(19) United States
(12) Patent Application Publication
(10) Pub. No.: US 2013/0268235 A1
(43) Pub. Date: Oct. 10, 2013

(54) SYSTEM AND METHOD FOR COMMUNICATING DISTANCE TRAVELLED BETWEEN A PLURALITY OF MOBILE DEVICES IN REAL-TIME

(71) Applicant: Eric Neil Piazza, Sarasota, FL (US)

(72) Inventor: Eric Neil Piazza, Sarasota, FL (US)

(73) Assignee: SOUTHDOWNS INTERACTIVE, LLC, Sarasota, FL (US)

(21) Appl. No.: 13/439,902

(22) Filed: Apr. 5, 2012

(51) Int. Cl. G06F 15/00

(52) U.S. Cl. 702/158

(57) ABSTRACT

The present invention generally relates to positioning systems. Specifically, this invention relates to a system and method for communicating distance travelled between a plurality of mobile devices when tracked across a contemporaneous period of time.

### FIELD OF THE INVENTION

The present invention generally relates to positioning systems. Specifically, this invention relates to a system and method for communicating distance travelled between a plurality of mobile devices when tracked across a contemporaneous period of time.

### BACKGROUND OF THE INVENTION

As the world becomes more global, so to do the options and actions we take with individuals in disparate locations. Social events and activities taking place where the participants are not centrally located are becoming more and more ubiquitous. Everything from business meetings to parties are occurring over the network of communications means and methods that are available in the present art.

Even personal events are frequently performed in this manner, as families, loved ones and friends are often spending times in disparate locations from one another as our society becomes truly global. As such, systems are being developed to allow for individuals to perform certain activities that they would otherwise do together in a single location, across a multitude of locations.

One problem that has arisen for individuals, especially those who enjoy outdoor activities, such as hiking, walking, jogging, running and other activities that involve traversing a distance of space, is that these activities become hard to enjoy in a meaningful way as a collective activity when the individuals of the collective are in disparate locations. This is especially the case when the activity is competitive or semi-competitive in nature (e.g., running).

With running/jogging as a focus, running as a group of individuals at disparate locations loses the inherent competitive or supportive elements that are present when a group of individuals run/jog together in the same location. When an individual cannot see or compare how they are doing with other individuals of the group in real-time, there is a disconnect and lack of motivation or desire that may arise.

Some systems in the present art have tried to overcome this by providing an individual with the ability, through the use of a mobile computing device, to run against themselves or a previously recorded run on a predefined course that was completed by someone else. However, these systems lack the ability to provide a real feeling of connection and temporal connectivity that would otherwise exist when two or more individuals are performing the same activity at the same time.

Therefore, there is a need in the art for a system and method for communicating relative distance travelled between a plurality of mobile devices when tracked across a contemporaneous period of time. These and other features and advantages of the present invention will be explained and will become obvious to one skilled in the art through the summary of the invention, drawings, brief description of the drawings and detailed description that follows.

### SUMMARY OF THE INVENTION

Accordingly, the present invention provides a system and method for communicating distance travelled between a plurality of mobile devices when tracked across a contemporaneous period of time.

According to an embodiment of the present invention, a computer implemented method for communicating relative distance travelled between a plurality of mobile computing devices includes the steps of: receiving a request to set a start time, from one of said plurality of mobile computing devices, wherein said start time is in reference to the start of an activity to be engaged in by users of said plurality of mobile computing devices; starting a timer at said start time; calculating the distance travelled at regular intervals on each of said mobile devices; transmitting the distance travelled and elapsed time from each of said plurality of mobile computing devices; receiving distance travelled and elapsed time updates from of all other mobile computing devices to each of said plurality of mobile computing devices; providing feedback to a user of said mobile device based at least in part on said distance travelled and elapsed time updates.

According to an embodiment of the present invention, a computer implemented method for communicating relative distance travelled between a plurality of mobile computing devices, includes the steps of: receiving a request to set a start time, from one of said plurality of mobile computing devices, wherein said start time is in reference to the start of an activity to be engaged in by users of said plurality of mobile computing devices; starting a timer at said start time; receiving a plurality of starting locations at said start time, wherein said plurality of starting locations is formed from individual starting locations provided by each mobile computing device of said plurality of mobile computing devices; receiving, from said plurality of mobile computing devices, a plurality of updated locations, wherein said plurality of updated locations is formed from individual locations provided by each mobile computing device of said plurality of mobile computing devices, wherein each individual location includes a time indicator; calculating a distance travelled for each mobile computing device of said plurality of mobile computing devices based at least in part on said starting location and said individual location; determining a relative distance between each mobile computing device of said plurality of mobile computing devices based at least in part on said distance travelled; transmitting said relative distance to each mobile computing device of said plurality of mobile computing devices.

According to an embodiment of the present invention, the starting location of said plurality of starting locations is disparate from the other starting locations of said plurality of starting locations.

According to an embodiment of the present invention, the time indicator is an expression of current time.

According to an embodiment of the present invention, the time indicator is an expression of time elapsed from said start time.

According to an embodiment of the present invention, each individual location is determined by a location determination system incorporated within the associated mobile computing device.

According to an embodiment of the present invention, the relative distance comprises a distance travelled by each mobile computing device of said plurality of mobile computing devices since said start time.

According to an embodiment of the present invention, a computer implemented system for communicating distance travelled between a plurality of mobile computing devices, said system comprising: a computing device; a first memory in the computing device, the first memory containing computer-executable code that, when processed by the computing device, performs steps comprising: receiving a request to set a start time, from one of said plurality of mobile computing devices, wherein said start time is in reference to the start of an activity to be engaged in by users of said plurality of mobile computing devices; starting a timer at said start time; calculating the distance travelled at regular intervals on each of said mobile devices; transmitting the distance travelled and elapsed time from each of said plurality of mobile computing devices; receiving distance travelled and elapsed time updates from of all other mobile computing devices to each of said plurality of mobile computing devices; communicating the relative distance travelled between each mobile computing device of said plurality of mobile computing devices based at least in part on said interval updates.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a schematic view of a computing device for use with an exemplary embodiment of the present invention;

FIG. 2 is a schematic overview of a network system for carrying out this invention in accordance with an embodiment of the present invention;

FIG. 3 is an exemplary graphical user interface for showing relative distance, in accordance with an embodiment of the present invention;

FIG. 4 is an exemplary method for communicating distance travelled between a plurality of mobile devices when tracked across a contemporaneous period of time, in accordance with an embodiment of the present invention; and

FIG. 5 is an exemplary method for communicating distance travelled between a plurality of mobile devices when tracked across a contemporaneous period of time, in accordance with an embodiment of the present invention.

### DETAILED SPECIFICATION

The present invention generally relates to positioning systems. Specifically, this invention relates to a system and method for communicating distance travelled between a plurality of mobile devices when tracked across a contemporaneous period of time.

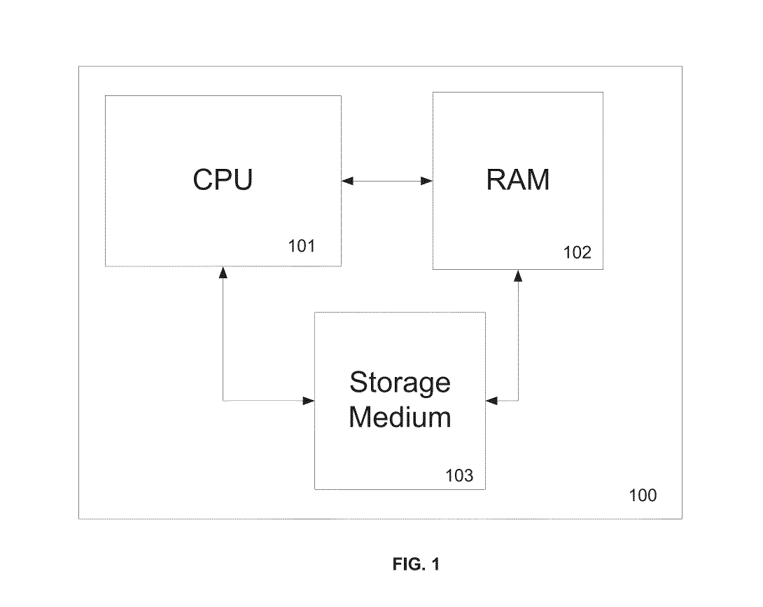

Turing now to FIG. 1, According to an embodiment of the present invention, the system and method is accomplished through the use of one or more computing devices 100. One of ordinary skill in the art would appreciate that a computing device 100 appropriate for use with embodiments of the present application may generally be comprised of one or more of a Central processing Unit (CPU) 101, Random Access Memory (RAM) 102, and a storage medium 103 (e.g., hard disk drive, solid state drive, flash memory). Examples of computing devices 100 usable with embodiments of the present invention include, but are not limited to, smartphones, tablet PCs, laptops, desktops, servers and GPS enabled devices. One of ordinary skill in the art would understand that any number of computing devices could be used, and embodiments of the present invention are contemplated for use with any computing device. Further, in certain embodiments of the present invention, some computing devices may only be able to portions of the methods described herein. In other embodiments, the system may require multiple computing devices to function properly.

In an exemplary embodiment according to the present invention, data may be provided to the system, stored by the system and provided by the system to users of the system across local area networks (LANs) (e.g., office networks, home networks), wide area networks (WANs) (e.g., the Internet) or any combination thereof. In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

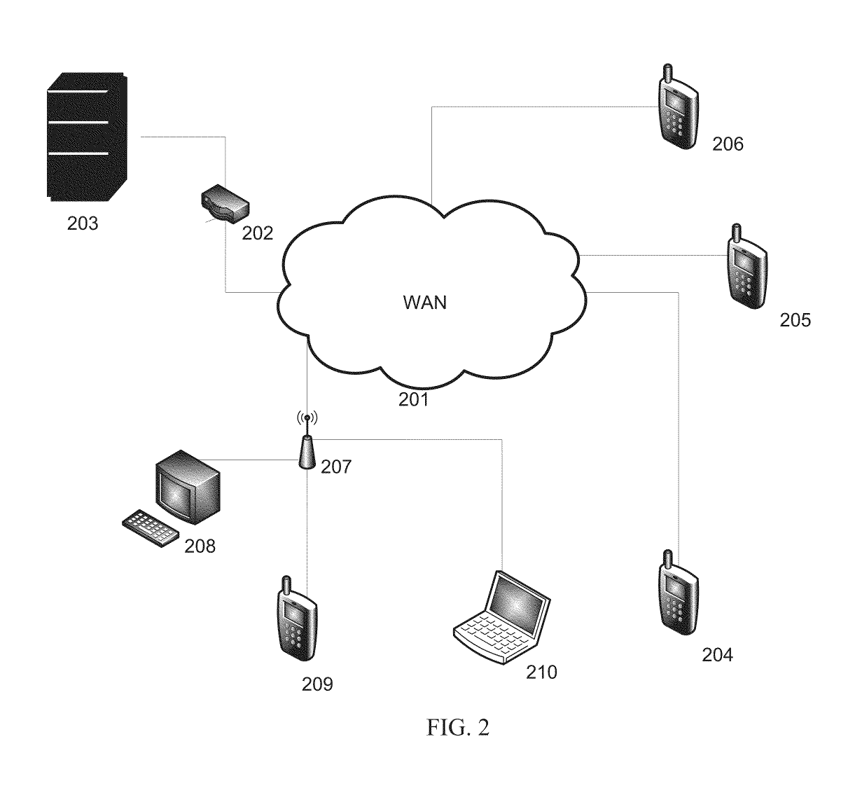

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 101 (e.g., the Internet).

According to an exemplary embodiment, as shown in FIG. 2, exchange of information through the WAN 201 or other network may occur through one or more high speed connections directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information.

Components of the system may connect to server 203 via WAN 201 or other network in numerous ways. For instance, a component may connect to the system i) through a computing device 204, 205, 206 directly connected to the WAN 101, ii) through a computing device 208, 209, 210 connected to the WAN 201 through a routing device 207 or iii) through a computing device 204, 205, 206 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network.

In other embodiments, the system may be executed without the use of an application server 203. For instance, the system and methods described herein (or portions thereof) may be executed on one or more computing devices 204, 205, 206 (e.g., software installed on one or more smartphones).

According to an embodiment of the present invention, the systems and methods herein described are configured to allow a plurality of individuals the ability to participate in an activity together, even in situations where one or more of the individuals is in a disparate location from the others. In a preferred embodiment of the present invention, a plurality of individuals utilizing mobile communications devices (e.g., smartphones, GPS tracking devices) located in disparate locations are provided the ability to participate in a walk/run/cycle together in a competitive or friendly manner with their times and distances travelled from various starting points being tracked by the system. For the remainder of this application, the system and method will be described with a focus on a plurality of individuals engaging in the activity of running. While embodiments of the present invention may be utilized by a plurality of individuals engaged in the activity of running, one of ordinary skill in the art would appreciate that there are numerous activities with which embodiments of the present invention could be utilized, and embodiments of the present invention are contemplated for use with any activity.

It is important to note that there is no requirement for the participants to be in the same location as one another. Each of the individuals may be in disparate locations or one or more of the individuals may be in disparate locations while others are in the same location. While the physical location of each individual is not important, it is important to the system that each of the participants have a computing device that is capable of identifying the particular participant's distance travelled at various time intervals during the execution of the methods described herein. Means for determining a participant's distance travelled include, but are not limited to, global positioning systems (GPS), location based systems (LBS) and triangulation of cellular or other wireless signals, accelerometers, or shoe sensors. In a preferred embodiment, the system is configured to utilize the GPS system integrated into a smartphone and provide information to a mobile application which is communicatively connected to the system and is configured to provide relevant data to the system as requested by the system or directed by the mobile application. One of ordinary skill in the art would appreciate that there are numerous methods for determining a participant's distance travelled and providing such data to the system, and embodiments of the present invention are contemplated for use with any method for determining a participant's distance travelled and providing such data to the system.

According to an embodiment of the present invention, the system is first configured to receive a request for a particular start time. The start time will be the time at which each of the participants (i.e., the plurality of individuals engaging in an activity) will begin their run. The start time can be selected in a variety of ways. For instance, a particular participant may send a start time request to the system which will deliver the request to one or more selected participants. The one or more selected participants may then accept or deny the start time. At the particular participant's direction, the start time will be set and the one or more selected participants who accepted the start time will be able to participate in the activity with the particular participant at the selected start time. In alternate embodiments, each of the participants may suggest start times, vote on start times, or otherwise provide start times in a manner whereby the start times may be approved by a collective of the participants. In another alternate embodiment, the start times may be scheduled by a computing device (e.g., application server). One of ordinary skill in the art would appreciate that there are numerous methods for selecting an appropriate start time, and embodiments of the present invention are contemplated for use with any method for selecting a start time.

According to an embodiment of the present invention, once the start time is selected, the system waits for the start time to near. Start times can be set for any period of time, whether in the immediate or distant future. Start times may also be set for an instant start (i.e., present time). Start times are generally time zone independent, meaning that all participants will be starting at the same instant, as opposed to a clock time. However, embodiments of the present invention can be utilized with start times that adjust for time zones, allowing all participants to participate at the start time in their local zone.

According to an embodiment of the present invention, the system can be configured to utilize start times provided in a variety of manners. For instance, the start time may be broadcast from a central computing device (e.g., server, master computing device) to the mobile computing devices of the participants. In this manner, every participant will have their start time start at an instant determined by a single central computing device. Alternatively, the start time may begin based on a timing mechanism (e.g., internal clock) local to the mobile computing device of each participant. Each embodiment has its advantages and disadvantages. For instance, broadcasting a start time from a central computing device introduces a single point of failure if the central computing device fails to broadcast the begin of the start time to each participant or may introduce delay or latency to the system as it may take longer to broadcast a start time to the various participants based on location and availability of quality communications links. One of ordinary skill in the art would appreciate that there are numerous methods for beginning a start time on a plurality of mobile computing devices, and embodiments of the present invention are contemplated for use with any method for beginning a start time on a plurality of mobile computing devices.

According to an embodiment of the present invention, at the beginning of the start time, each of the mobile computing devices is configured to identify the position data of the particular device and record that position data. The position data taken at the beginning of the start time will identify the location of each of the mobile computing devices and will be used as a reference point for distance travelled from the start time until sometime in the future at which point the participants cease the activity.

According to an embodiment of the present invention, as time elapses from the start time, updates are taken at intervals. Updates are taken from each of the participant's mobile computing device and are comprised of positional data taken at the time of the update. The positional data is compared to previously recorded positional data and a distance between the two points is calculated. In a preferred embodiment, the distance between the position data of each update is calculated and summed for a total distance and provided to the system. In this manner, each time an update is processed, the distance calculated is between the most recent previous positional data and the current positional data, representing a nearly true and accurate calculation of the distance travelled since the beginning of the start time. The more frequent the updates are taken, the true the distance calculation will be. The determination of how frequent to take updates can be based on a variety of preferences (e.g., conservation of power, desire for accuracy). In certain embodiments, the system may be configured to allow the participant to select the frequency at which updates are taken to allow the participant to make the determination that fits their particular needs.

In a preferred embodiment, the system is configured to receive a stream of updates from the various mobile computing devices utilized by the participants and process a real-time or near real-time display of how far the participants have travelled in relation to one another, even where their start points are at disparate locations. For instance, if a first participant is in California and has run 3 miles from the beginning of the start time and second participant is in New York and has run 4 miles from the beginning of the start time, the system may be configured to calculate and provide feedback on the mobile computing devices of the first and second participants identifying that the second participant has travelled further than the first participant since the beginning of the start time. Feedback may be provided in one or more formats, such as graphical representations, audio feedback, haptic feedback (e.g., vibration) or any combination thereof. One of ordinary skill in the art would appreciate that there are numerous types of feedback that could be utilized with embodiments of the present invention and embodiments of the present invention are contemplated for use with any type of feedback.

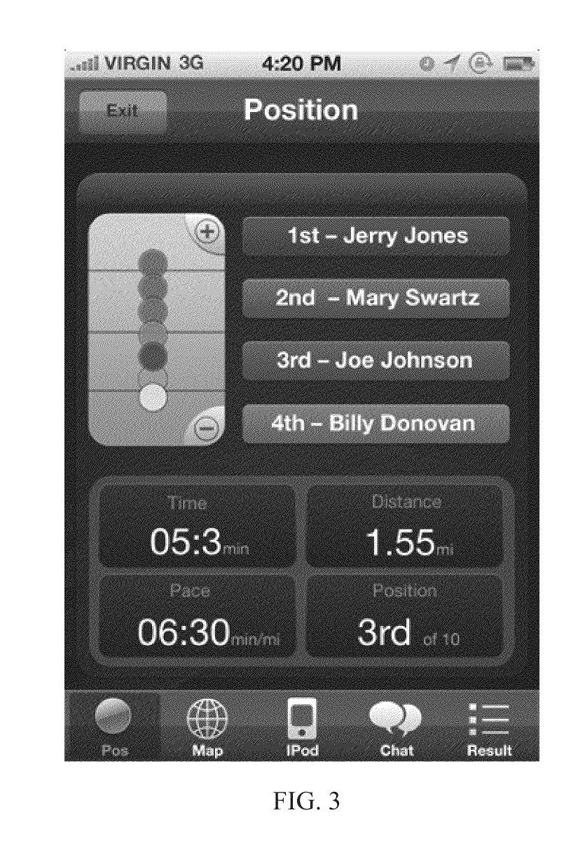

Turning now to FIG. 3, an exemplary embodiment of a graphical representation (graphical feedback) that may be transmitted and displayed on a mobile computing device of each participant, in accordance with an embodiment of the present invention, is shown. The graphical representation may consist of a progress bar identifying the various participants in a manner that allows for the delineation of the various participants, with each graphical representation of a participant being represented at a scaled distance from the graphical representations of other participants. This allows the participants to feel as if they are participating in a race (or other activity) even where their courses/paths are at disparate locations. Additionally, ancillary components may be utilized to increase the value of the graphical representation, such as timers, distance meters, pace calculators, position and a legend identifying the various participants. One of ordinary skill in the art would appreciate that there are numerous components that may be utilized with user interfaces in accordance with embodiments of the present invention, and embodiments of the present invention are contemplated for use with any component utilizable in a user interface.

According to an embodiment of the present invention, the systems and methods described herein can be configured to send and/or process audio feedback to the mobile computing devices of the participants. The audio feedback may be based, at least in part, on the received distance data. In this manner, the participants may be notified of relative positions of the other participants without having to look at any graphical representation of the data. For example, a voice alert notifying the participant that they are in second place or that the participant is 200 meters ahead or behind another participant. One of ordinary skill in the art would appreciate that there is numerous types of data that may be provided through various types of audio alerts, and embodiments of the present invention are contemplated for use with any type of data and any type of audio alert.

According to an embodiment of the present invention, the systems and methods described herein can be configured to send and/or process haptic feedback to the mobile computing devices of the participants. The haptic feedback may be based, at least in part, on the received distance data. In this manner, the participants may be notified of relative positions of the other participants without having to look at any graphical representation of the data. For example, the mobile device of a participant may vibrate when he/she is passed or passes another participant. One of ordinary skill in the art would appreciate that there is numerous types of haptic feedback that may be provided through the mobile devices of participants, and embodiments of the present invention are contemplated for use with any type of haptic feedback.

According to an embodiment of the present invention, the systems and methods described herein can be configured to go for any duration or other targetable metric. For instance, the system and methods described herein could be configured to run for a specific distance, a specific amount of time, until a participant stops the timer, until the system loses contact with one or more participants, until the mobile computing devices sends a terminate signal/command or any combination thereof. One of ordinary skill in the art would appreciate that there are numerous triggers that could be utilized to terminate the methods described herein, and embodiments of the present invention are contemplated for use with any trigger.

According to an embodiment of the present invention, the system may be further configured to provide the participants with the ability to communicate with one another. For instance, the system may provide the users the ability to communicate via voice, text, visual data (e.g., still images, video images) or any combination thereof. In this manner, the participants are provided with a more social experience and are able to not only compare their activity data, but the aesthetics or other characteristics of their activity as well.

According to an embodiment of the present invention, the system may be further configured to calculate relative difficulties for various activities as well. For instance, the system may be configured to determine both horizontal and vertical distance travelled, allowing for a more complete picture of the difficulty of the particular activity faced by each participant.

According to an embodiment of the present invention, the system may be configured to record, store or otherwise save data related to present and historical activities taken by the participants. This data can be relational (e.g., between two or more particular participants) or statistical (e.g., between two or more unrelated or non-specific participants). In this manner, participants may not only be able to determine relational data between the participants in a current activity, but be able to compare that relational data to previously stored relational data. For instance, participants may be compared to previous times/distances, “best” times/distances, or the times/distances of other individuals (e.g., famous athletes, times/distances of friends) for particular activities. This may be combined and displayed across all mobile devices, or only on selected mobile devices (e.g., only the mobile device of the participant that has a previously recorded activity).

According to an embodiment of the present invention, the system may be configured to allow participants to setup an activity, start time and other characteristics via one or more computing devices, including non-mobile computing devices (e.g., desktop computers). In this manner, participants may preconfigure the activity prior to the start time by utilizing a convenient computing device. This may be useful when there are a large number of participants and contacting those participants may be complicated through the use of a mobile computing device alone.

### Exemplary Embodiment

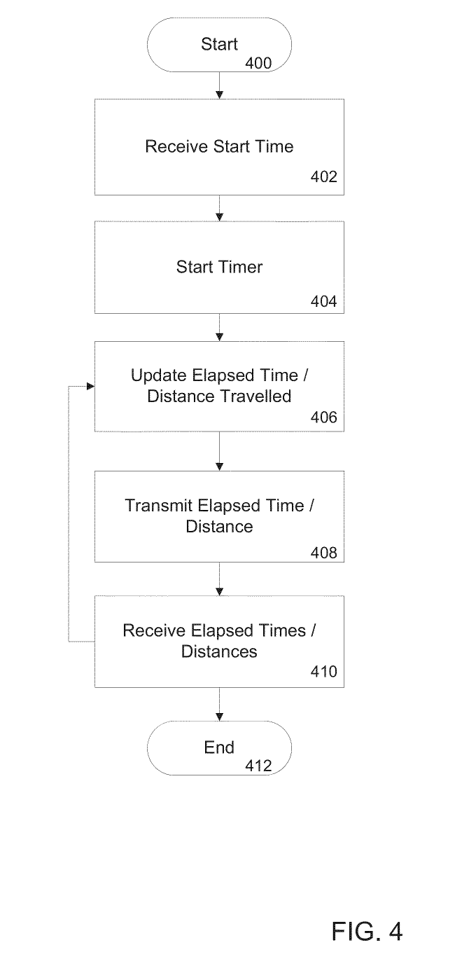

Continuing to FIG. 4, an exemplary method for communicating distance travelled between a plurality of mobile devices when tracked across a contemporaneous period of time, is shown. In particular, the process of FIG. 4 is from the perspective of a mobile computing device in use by a participant. One of ordinary skill in the art would appreciate that the process could take place concurrently across multiple mobile computing devices, with information being synchronized there between. The process starts at step 400, where one or more participants utilizing mobile computing devices are interested in performing an activity together at one or more distal locations. At step 402, the mobile computing device of the participant receives an activity start time set a particular start time for the event to begin and occur.

At step 404, the start time is reached and the mobile computing device starts the timer for the activity and begins tracking the distance travelled utilizing one of the methods for determining location as previously noted in [0032].

At step 406, which occurs at some predetermined time/interval, the mobile computing device records the elapsed time and determines the current distance travelled of the mobile computing device utilizing one of the methods for determining distance travelled as previously noted above. For example, the mobile computing device may calculate the distance travelled using the current location of the mobile device and the last recorded location of the mobile computing device. In that case, the first time the mobile computing device is performing this step, the total distance travelled thus far is the distance between the two points; and on any other iteration of the method, the distance travelled between the two points is added to the previous total distance travelled.

At step 408, the mobile computing device transmits the elapsed time and total distance travelled. This transmission could be to a server that is configured to retransmit this information to the mobile computing devices of the other participants or it could be transmitted directly to the mobile computing devices of the other participants if the system is configured in a peer-to-peer embodiment.

At step 410, the elapsed times and distances of the various participants are shared amongst the participants. The mobile computing device of each individual participant is then configured to process the times and distances and provides visual and/or audio feedback to participant with respect to the distances of other devices relative to current device. Steps 406-410 may be repeated continuously for as long as the participants wish to participate in the activity.

At step 412, the process ends. End results or other performance results may be provided to the various participants, including how the current results compare to historical results or other results provided or stored in the system.

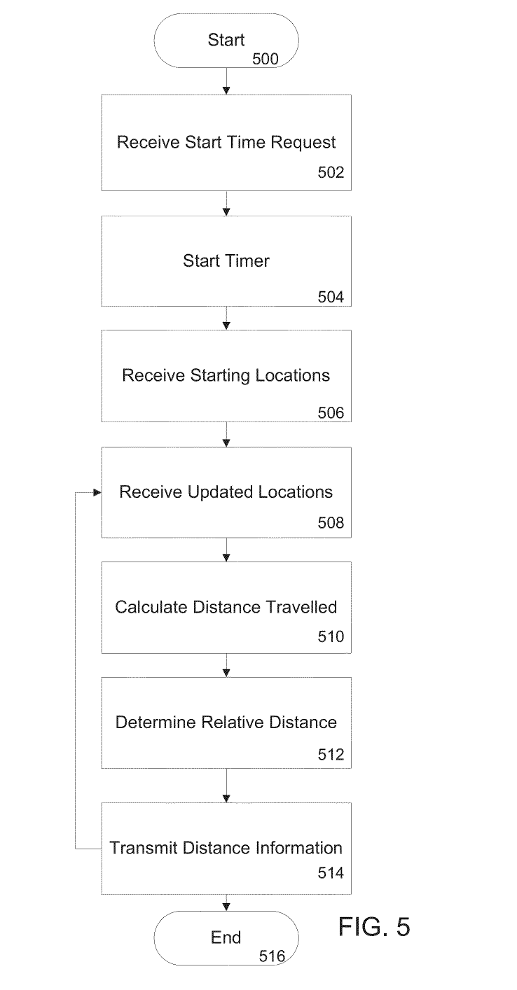

Continuing to FIG. 5, an alternate method for communicating distance travelled between a plurality of mobile devices in real-time, is shown. In particular, the process of FIG. 5 is from the perspective of a central server communicating with a plurality of mobile devices, and using location data to calculate distance travelled. The process starts at step 500, where one or more participants utilizing mobile computing devices are interested in performing an activity together at one or more distal locations. At step 502, the system receives a start time request to set a particular start time for the event to begin and occur. Once the start time has been confirmed and approved by the various participants, the system is preconfigured to begin processing the activity at the given start time.

At step 504, the start time is reached and the system starts the timer for the activity. An initial request is sent to each of the mobile computing devices of the various participants to transmit a starting location for each individual mobile computing device.

At step 506, each of the mobile computing devices responds to the system with an initial starting location for each of the various mobile computing devices. The system records the starting location and awaits further communications from the various mobile computing devices.

At step 508, The system receives a stream of updates from the various mobile computing devices, with each update carrying information related to either the distance travelled or the current location of the mobile computing device. In the presently described method, a location for each of the various mobile computing devices is transmitted to the system at each update.

At step 510, the system effects the determination of how far the mobile computing device has travelled since the previous update. The system effects this determination by calculating the distance between the previous update or starting location and the currently provided location.

At step 512, the system calculates a distance travelled for each of the various mobile computing devices. The system then builds data related to how far apart each of the various mobile computing devices are with respect to the distances travelled and not the distance actually between the various mobile computing devices (comparative distance).

At step 514, the system may then transmit this data to the various mobile computing devices for display to the participants.

Steps 508-514 may be continually iterated through over any length of time, as described previously above.

At step 516, the process ends. End results or other performance results may be provided to the various participants, including how the current results compare to historical results or other results provided or stored in the system.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, VB.Net, C#, Objective-C, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented method for communicating distance travelled between a plurality of mobile computing devices, said method comprising the steps of:
receiving a request to set a start time, from one of said plurality of mobile computing devices,
wherein said start time is in reference to the start of an activity to be engaged in by users of said plurality of mobile computing devices;
starting a timer at said start time;
calculating, at each mobile device of said plurality of mobile devices, a distance travelled by said mobile device, at regular intervals;
transmitting the distance travelled and elapsed time from each mobile device of said plurality of mobile computing devices;
receiving, at each mobile device of said plurality of mobile devices, the distance travelled and elapsed time updates from of all other mobile computing devices of said plurality of mobile computing devices;
providing feedback to a user of said mobile device based at least in part on said distance travelled and elapsed time updates.

2. The method of claim 1, wherein each starting location of said plurality of starting locations is disparate from the other starting locations of said plurality of starting locations.

3. The method of claim 1, wherein said relative distance comprises a distance travelled by each mobile computing device of said plurality of mobile computing devices since said start time.

4. The method of claim 1, wherein each of said distances of said interval updates comprises a distance travelled by one of said mobile computing devices.

5. A computer implemented system for communicating relative distance travelled between a plurality of mobile computing devices, said system comprising:
a computing device;
a first memory in the computing device, the first memory containing computer-executable code that, when processed by the computing device, performs steps comprising:
receiving a request to set a start time, from one of said plurality of mobile computing devices,
wherein said start time is in reference to the start of an activity to be engaged in by users of said plurality of mobile computing devices;
starting a timer at said start time;
calculating, at each mobile device of said plurality of mobile device, a distance travelled by said mobile device, at regular intervals;
transmitting the distance travelled and elapsed time from each mobile device of said plurality of mobile computing devices;
receiving, at each mobile device of said plurality of mobile devices, the distance travelled and elapsed time updates from of all other mobile computing devices of said plurality of mobile computing devices;
providing feedback to a user of said mobile device based at least in part on a relative distance travelled between each mobile computing device of said plurality of mobile computing devices based at least in part on said distance travelled and elapsed time updates.

6. The system of claim 5, wherein each starting location of said plurality of starting locations is disparate from the other starting locations of said plurality of starting locations.

7. The system of claim 5, wherein said distance comprises a distance travelled by each mobile computing device of said plurality of mobile computing devices since said start time.

8. The system of claim 5, wherein each of said distances of said interval updates comprises a distance travelled by one of said mobile computing devices.

9. A computer implemented method for communicating distance travelled between a plurality of mobile computing devices, said method comprising the steps of:
receiving a request to set a start time, from one of said plurality of mobile computing devices,
wherein said start time is in reference to the start of an activity to be engaged in by users of said plurality of mobile computing devices;
starting a timer at said start time;
receiving a plurality of starting locations at said start time,
wherein said plurality of starting locations is formed from individual starting locations provided by each mobile computing device of said plurality of mobile computing devices;
receiving, from said plurality of mobile computing devices, a plurality of updated locations,
wherein said plurality of updated locations is formed from individual locations provided by each mobile computing device of said plurality of mobile computing devices,
wherein each individual location includes a time indicator;
calculating a distance travelled for each mobile computing device of said plurality of mobile computing devices based at least in part on said starting location and said individual location;
determining a relative distance between each mobile computing device of said plurality of mobile computing devices based at least in part on said distance travelled;
transmitting said relative distance to each mobile computing device of said plurality of mobile computing devices.

10. The method of claim 9, wherein each starting location of said plurality of starting locations is disparate from the other starting locations of said plurality of starting locations.

11. The method of claim 9, wherein said time indicator is an expression of current time.

12. The method of claim 9, wherein said time indicator is an expression of time elapsed from said start time.

13. The method of claim 9, wherein each individual location is determined by a location determination system incorporated within the associated mobile computing device.

14. The method of claim 9, wherein said comparative distance comprises a distance travelled by each mobile computing device of said plurality of mobile computing devices since said start time.
